(19) United States
(12) Patent Application Publication
(10) Pub. No.: US 2002/0093508 A1
(43) Pub. Date: Jul. 18, 2002

(54) Orthogonal memory for digital imaging devices

(75) Inventor: Mark Sandford, Lake Forest, CA (US)

Correspondence Address: JOHN A. SMART, 708 BLOSSOM HILL RD., #201, LOS GATOS, CA, 95032, US

(73) Assignee: LightSurf Technologies, Inc.

(21) Appl. No.: 10/052,700

(22) Filed: Jan. 17, 2002

Related U.S. Application Data
(60) Provisional application No. 60/262,869, filed on Jan. 18, 2001.

(51) Int. Cl. G06F 12/06; G09G 5/39; G06F 12/02

(52) U.S. Cl. 345/571; 345/567; 345/531

(57) ABSTRACT

An orthogonal memory is described that provides an improved method for converting image data into a bit plane format suitable for image compression operations, using a custom dual port memory. The memory comprises a matrix of memory cells that are addressable in orthogonal directions. Upon receipt of image information for storage, the image information is stored in the memory by storing each data word of the image information in a row of the matrix. Individual bit planes of the image information may be easily retrieved from the memory by retrieving individual columns of bits from the corresponding columns of the matrix, thus providing a highly efficient method for storing and accessing image information used to create bit planes.

### RELATED APPLICATIONS

The present application is related to and claims the benefit of priority of the following commonly-owned provisional application(s): application Ser. No. 60/262,869 (Docket No. LS/0014.00), filed Jan. 18, 2001, entitled “Orthogonal Memory for Digital Imaging Devices”, of which the present application is a non-provisional application thereof. The disclosure of the foregoing application is hereby incorporated by reference in its entirety, including any appendices or attachments thereof, for all purposes.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF TEE INVENTION

1. Field of the Invention

The present invention relates generally to digital image processing and, more particularly, to improved techniques for accessing/processing information stored in memory used for representing digital images.

2. Description of the Background Art

Today, digital imaging, particularly in the form of digital cameras, is a prevalent reality that affords a new way to capture photos using a solid-state image sensor instead of traditional film. A digital camera functions by recording incoming light on some sort of sensing mechanisms and then processes that information (basically, through analog-to-digital conversion) to create a memory image of the target picture. A digital camera's biggest advantage is that it creates images digitally thus making it easy to transfer images between all kinds of devices and applications. For instance, one can easily insert digital images into word processing documents, send them by e-mail to friends, or post them on a Web site where anyone in the world can see them. Additionally, one can use photo-editing software to manipulate digital images to improve or alter them. For example, one can crop them, remove red-eye, change colors or contrast, and even add and delete elements. Digital cameras also provide immediate access to one's images, thus avoiding the hassle and delay of film processing. All told, digital photography is becoming increasingly popular because of the flexibility it gives the user when he or she wants to use or distribute an image.

In order to generate an image of quality that is roughly comparable to a conventional photograph, a substantial amount of information must be captured and processed. For example, a low-resolution 640×480 image has 307,200 pixels. If each pixel uses 24 bits (3 bytes) for true color, a single image takes up about a megabyte of storage space. As the resolution increases, so does the image's file size. At a resolution of 1024×768, each 24-bit picture takes up 2.5 megabytes. Because of the large size of this information, digital cameras usually do not store a picture in its raw digital format but, instead, apply compression technique to the image so that it can be stored in a standard compressed image format, such as JPEG (Joint Photographic Experts Group). Compressing images allows the user to save more images on the camera's “digital film,” such as flash memory (available in a variety of specific formats) or other facsimile of film. It also allows the user to download and display those images more quickly.

Current memory architecture in widespread use for storing/processing digital images (e.g., synchronous DRAMs—SDRAMs) is optimized for sequential data access in a horizontal manner, such as page-based or row-based access. For example, in the SDRAM memory commonly employed in PCs, horizontal access may be achieved on the order of 710 nanoseconds. This speed results from a pre-fetch pipelining mechanism, which is optimized for fetching the next data element (e.g., machine word) in a given row (“page”). Vertical access (e.g., accessing a pixel value below), in contrast, requires around 120 nanoseconds, a ten-fold increase in access cost. This increased cost results from the time-intensive task of switching to another row of memory cells. Here, the underlying memory access mechanism must be reconfigured to switch to the next memory page 2 to access the next group of bits.

One approach to mitigating the above limitation of current memory architecture is to employ alternative memory architecture—that is, forego use of RAM that is page oriented. One such example is static RAM (SRAM). Unfortunately, that approach has distinct disadvantages in terms of greatly increased cost, power requirements, and larger chip size. It is instead advantageous to find a solution that may be implemented using less-costly page-based memory architecture, if such a solution is possible.

As part of ways to encode data and efficiently represent images (i.e., getting good compression), one of the goals is to provide a mechanism for progressive compression. Progressive compression refers to the compressing the image in a format that stores the most significant portions of data at the beginning of the file, followed by multiple levels of subsequent data that refines the image to a best quality. This staggered format allows a user or application to trade-off the level of quality and data size, or in the case of unreliable communications allows an image to be reconstituted up to the point of transmission failure, at a reduced quality, which is better than a total failure. This feature also allows the possible refinement of image quality over time as information arrives over a slow link, or time separated transmission that might increase convenience. One of the ways to do this is to separate an image into individual bit planes. Here, the most significant bits of a data word have the most significant information—that is, they contribute the largest amount of value in the representation of an image. The least significant bits more finely resolve the data values and, thus, further refine the image. The problem with the foregoing is that general purpose processors are optimized for working on word-size chunks of data (e.g., eight bits, 16 bits, 32 bits, or the like). In other words, current-day processors do not possess mechanisms that are optimized for bit-level extraction, manipulation, and processing. At the same time, given the ever-increasing popularity and demand for digital image processing and applications, there is a great interest in being able to efficiently extract all of the bits in a plane. In traditional processor architectures, one can extract individual bits by performing a logical AND operation (or by sometimes performing a specific instruction to extract a single bit). However, such an operation is geared towards extracting bits from a single word. The operation is inefficient for processing a large number of words to generate one or more bit planes. Although there are special-purpose processors optimized for large-scale extraction of bits, such processors, given their specialized nature, have not found wide application. Accordingly, today there is no large-scale mechanism for a general-purpose processor to access bit planes from data words.

All told, using existing processor architecture today, the task of creating bit planes is very inefficient. For example, in order to generate a bit plane with a depth of 16 bits, a system would have to, for each pixel location, access sixteen words and perform an AND operation to extract the corresponding bit instruction on each word in order to extract a corresponding bit plane. Accordingly, the present-day approach is very time consuming and resource intensive, requiring for instance 16 reads, 16 logical “AND”, 15 shift operations to align the bits into the bit plane word, with 15 logical “OR” operations to combine the bits into a word. Accordingly, a better solution is sought.

### GLOSSARY

The following definitions are offered for purposes of illustration, not limitation, in order to assist with understanding the discussion that follows.

Big-endian: Big-endian is an order in which the “big end” (most significant value in the sequence) is stored first. For example, in a big-endian computer, the two bytes required for the hexadecimal number 4F52 would be stored as 4F52 in storage. IBM's 370 computers, most RISC-based computers, and Motorola microprocessors use the big-endian approach.

Flip-flop: A device that may assume either one of two reversible, stable states. The flip-flop is used as a basic control element in computer and communications systems.

Little-endian: Little-endian is an order in which the “little end” (least significant value in the sequence) is stored first. For example, in a little-endian computer, the two bytes required for the hexadecimal number 4F52 would be stored as 524F in storage. Intel processors (CPUs) and DEC Alphas use the little-endian approach.

LSB: Abbreviation for least significant bit. This is the bit of a binary number giving the number of ones, the last or rightmost bit when the number is written in the usual way.

MSB: Abbreviation for most significant bit. This is the bit with the greatest weight, and is the first or leftmost bit when the number is written in the usual way.

SRAM: Abbreviation for static random access memory. SRAM retains data bits in its memory as long as power is being supplied. Unlike dynamic RAM (DRAM), which stores bits in cells consisting of a capacitor and a transistor, SRAM does not have to be periodically refreshed. Static RAM provides faster access to data.

Two's (2's) complement: Two's complement representation is a convention used to represent signed binary integers. In binary representation (positional notation), each bit has a weight which is a power of two. With two's complement notation, all integers are represented using a fixed number of bits with the leftmost bit (i.e., the “sign bit”) given a negative weight. To get the two's complement negative notation of an integer, one writes out the number in binary, then inverts the digits and adds one to the result. This representation is optimized for implementations of arithmetic hardware, and thus most computer hardware is based on this format, but this format makes the representation of negative values more abstract.

One's (1's) complement: One's complement representation is a convention used to represent signed binary integers. In binary representation (positional notation), each bit has a weight which is a power of two. With one's complement notation, all integers are represented using a fixed number of bits with the leftmost bit (i.e., the “sign bit”) indicating the sign value. To get the one's complement negative notation of an integer, one writes out the number in binary, then sets the MSB to a ‘1’ value, such that a positive and negative number of the same value differ in only in the value of the MSB. This representation separates the sign element from the magnitude element, and allows for easy extraction of value, exclusive of the sign. Positive One's and Two's complement values are identical, but they differ greatly in their representation of negative values.

Register File: A custom high-speed memory, used in specialty applications. A register file differs from other types of memory (DRAM or SRAM) in that rather than using an array of memory cells each bit is stored in a standard logic flip-flop. While flip-flops are significantly larger and more power hungry than other storage technologies, they are faster and can much more easily be customized into unique configurations.

### SUMMARY OF THE INVENTION

An orthogonal memory is described that provides an improved method for converting between data stored in amplitude values and bit plane format and the reverse conversion using a special dual-ported memory. The memory comprises a matrix of memory cells that are addressable in orthogonal directions. Upon receipt of image information for storage, the image information is stored in the memory by storing each data word of the image information in a row of the matrix. Here, the term “row” and “column” simply indicate orthogonal addressability; there is no requirement that the memory cells themselves are actually physically configured (apart from addressability) in a particular orientation. Individual bit planes of the image information may be easily retrieved from the memory by retrieving individual columns of bits from the corresponding columns of the matrix, thus providing a highly efficient method for storing and accessing image information used to create bit planes.

An orthogonal memory device constructed in accordance with the present invention comprises data inputs; an array of storage elements or units for bit storage of information arriving from the data inputs; an address decoding mechanism for selecting a particular row or column of storage elements, the address decoding mechanism supporting read access in a direction that is orthogonal to that for write access; and data outputs to output data read from the storage elements.

### BRIEF DESCRIPTION OF THE DRAWINGS

FIG. 1 is a block diagram of an orthogonal memory of the present invention.

FIG. 2 is a flowchart illustrating a method of the present invention for storing and retrieving image information for efficiently creating bit planes.

FIG. 3A is a block diagram illustrating a standard logic D-type flip-flop that may be used for implementing the orthogonal memory of the present invention.

FIG. 3B is a block diagram illustrating the use of multiple flip-flop devices to store multiple bits in parallel, commonly referred to as a register or latch.

FIG. 3C is a block diagram illustrating a simple 4×4 orthogonal memory constructed in accordance with the present invention.

### DETAILED DESCRIPTION OF A PREFERRED EMBODIMENT

The following description will focus on the presently preferred embodiment of the present invention, which may be implemented in a low-cost ASIC (application-specific integrated circuit) chip. The present invention, however, is not limited to just ASIC-based implementations. Instead, those skilled in the art will find that the present invention may be advantageously embodied in other environments, including, for example, a field programmable gate array (FPGA) chip. Therefore, the description of the exemplary embodiments that follows is for purposes of illustration and not limitation.

I. ASIC-Based Implementation

The present invention may be implemented on an ASIC. An ASIC is an integrated circuit or “chip” that has been built for a specific application. Integrated circuits are traditionally designed with general-purpose functions that allow designers to design systems in the form of integrated circuit boards by connecting integrated circuits with selected functions to one another. For example, most integrated circuits have general functions, such as combinational logic, shift registers, and the like, and are connected to one another on circuit boards. Designers may use ASIC to consolidate many integrated circuits into a single package thereby reducing circuit board size requirements and power consumption. An ASIC implements custom functionality according to a description, which is provided in an abstract technology-in dependent fashion for instance using a Hardware Description Language (HDL), such as VHDL (Very High Speed Integrated Circuit Hardware Description Language) or Verilog Hardware Description Language.

ASICs may incorporate programmable logic arrays, field programmable gate arrays, cell based devices, and fully custom designed devices. ASICs may include general function circuits that are connected to perform specific applications as systems, such as, a disk controller, a communications protocol, a bus interface, a voice coder, and the like. An ASIC may include on a single integrated circuit the circuitry that is typically built on a circuit board. ASIC devices are available from a variety of suppliers, including Fujitsu, Hyundai (recently renamed Hynix) Electronics America, and Texas Instruments.

The use of an ASIC-based implementation is presented for purposes of illustrating the basic underlying architecture and operation of the present invention. An ASIC-based implementation is not necessary to the invention, but is used to provide a framework for discussion. Instead, the present invention may be implemented in any type of circuitry capable of supporting the processes of the present invention presented in detail below.

II. Orthogonal Memory Architecture

A. Introduction

In image processing, there exists a need for an “orthogonal memory” of the present invention. More particularly, to efficiently encode images in a progressive format, the data is split into bit planes to prioritize the data in successive levels of visual importance. Using traditional methods with microprocessors, each specific bit would need to ANDed with an appropriate bit mask to extract out the desired bit, repeated over the bits of the word—a very time consuming operation, with further operations required to assemble each of the extracted bits into the new bit plane format. A memory has been created where writing could be done in one direction, on one axis data for 16 words, and it would be read out in a column of pixel data in the orthogonal, or bit plane format as a separate word. By doing this, all of the bit planes could be split out resulting in 16 writes and 16 reads, to extract a total of 256 bits. A traditional microprocessor implementation would require 256 bit extraction operations each of which would be at least 3 cycles in duration (AND for the extract operation, Shift for alignment and OR to combine the bits into a resultant bit-plane word, plus instructions to loop over all these operations), thus the present invention reduces 768 processor cycles to a mere 32, a 24 times improvement (and possibly more depending on the efficiency of the processor architecture being used).

B. Orthogonal Memory Design

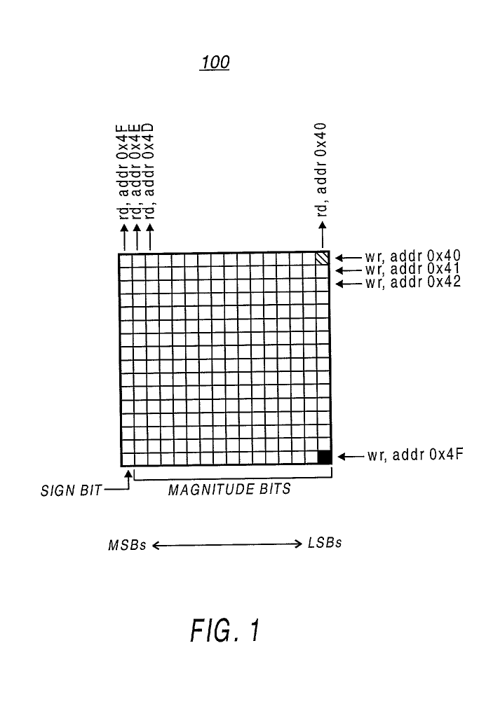

FIG. 1 illustrates a dual-port register file orthogonal memory 100 constructed in accordance with the present invention. The memory architecture 100 comprises a plurality of addressable memory words, each word comprising a plurality of memory cells with each memory cell storing a single bit value. The orthogonal memory is a matrix register bank (e.g., 16×16) that allows the system to write data horizontally and read data vertically. By virtue of being dual ported, the orthogonal memory 100 includes two activation mechanisms that may be triggered by different addresses. Here, the memory architecture 100 includes orthogonally-connected address buses so that the memory's machine words (e.g., 16-bit words) can be written to in one direction (e.g., horizontally, as indicated in the figure) and read out from another direction (e.g., vertically, as indicated in the figure).

With this basic approach, the memory architecture 100 may be partitioned in a manner that supports more efficient access for memories that store bit plane image data. Data storage and retrieval occurs as follows. When a write operation occurs, the controlling system (e.g., including processor and bus) will write in a data value (e.g., 16-bit word) to the memory architecture 100 in one direction. When a read operation occurs, the system will read out all of the bits for a column (of pixels) at once from another (orthogonal) direction. With this basic approach, the memory architecture may be partitioned in a manner that supports more efficient access for memories that store bit plane image data.

FIG. 1 illustrates the architecture. As shown, the most significant bits are all stored on one side (e.g., the left-hand side of the figure) of the memory architecture 100, while the least significant bits are all stored on an opposing side (e.g., the right-hand side of the figure). Of course those skilled in the art will appreciate that “left” and “right” are relative terms used for demonstrative purposes. Instead, the terms demonstrate the accessibility of individual bits with respect to logical addressing schemes. There is no requirement that the bits must be stored in a particular physical configuration.

C. Orthogonal Memory Operation

When a write operation occurs, the controlling system (e.g., including processor and bus) will write in a data value (e.g., 16-bit word) to the memory architecture 100. The data that is written into the memory is converted from 2's complement representation to a sign plus magnitude representation (1's complement). Writing 0×8000 (2's complement) to the memory is a special case and is converted to 0×FFFF (sign plus magnitude). In the currently preferred environment, the whole memory is mapped into a processor's address space (e.g., DSP) on the y-bus (as indicated in FIG. 1). The conversion between 2's complement and 1's complement is required such that when the MSB bit plane, which represents the sign bit is removed, the remaining bits change significance in 2's complement but retain their significance in 1's complement; thus 1's complement is preferred for subsequent operations. This conversion would not be required in implementations in which only positive values are allowed to exist as positive 1's and 2's complement values are identical and purely magnitude based; the significance applies only for negative values. Outputted data may be provided in 1's complement or 2's complement format, as required.

When a read operation occurs, the system will read out all of the bits for a column (of pixels) at once. When reading data from address 0×4F, for example, one gets all sign bits. When reading at address 0×40, one reads all LSBs. The LSB of the read data from addr (address) 0×40 equals the LSB of the write data to addr 0×40 (marked with crosshatching). The MSB of the read data from addr 0×40 equals the LSB of the write data to add r0×4F (marked black).

Accordingly, bit plane information may be stored in the memory architecture as follows. Incoming data (e.g., 16-bit word) is written to a horizontal row at a given memory address, such as memory address 0×40, with its most significant bits on the left-hand side of the figure, and its least significant bits on the right hand side of the figure. The incoming data continues to be stored (e.g., sequentially), so that the second 16-bit word is stored at the next memory row or word (e.g., memory address 0×41 in the figure), the third 16-bit word is stored at memory address 0×42, and so forth and so on until all of the data is stored in the memory. Depending on the desired ordering of the bit-plane data, the writes may be implemented top to bottom or bottom to top to reverse the bit ordering as desired for any particular implementation.

The operation of reading out the stored data effectively occurs in a perpendicular direction—that is, by reading out vertical columns of bits or elements. In accordance with the present invention, the data is retrieved by starting with the column of most significant bits or maximum bit position of interest, then retrieving, in succession, columns of (successively) lesser-significant bits. Thus, for the memory addresses shown in FIG. 1, the controlling system first retrieves the vertical column of bits at addresses 0×4F. The data continues to be retrieved sequentially, so that the second set of bits retrieved comes from the next memory column (e.g., memory address 0×4E in the figure), the third set of bits is retrieved at memory address 0×4D, and so forth and so on until all of the data (or a desired portion of the data) is retrieved from the memory. If the data input is signed, the left most column contains the sign bit; this will generally be required to be read, with a sub-region of the other bit planes.

Although the foregoing illustrates sequential writing of data, the memory architecture 100 provides flexibility as to how the data is written. Thus, for example, the bits for a given word may be written in little-endian or big-endian format as desired for a particular platform (e.g., Intel processor architecture versus Motorola processor architecture). Similarly, the memory architecture 100 provides flexibility as to how data is read. If certain bit planes are of interest, the controlling system need only read the column of bits pertaining to those bit planes of interest.

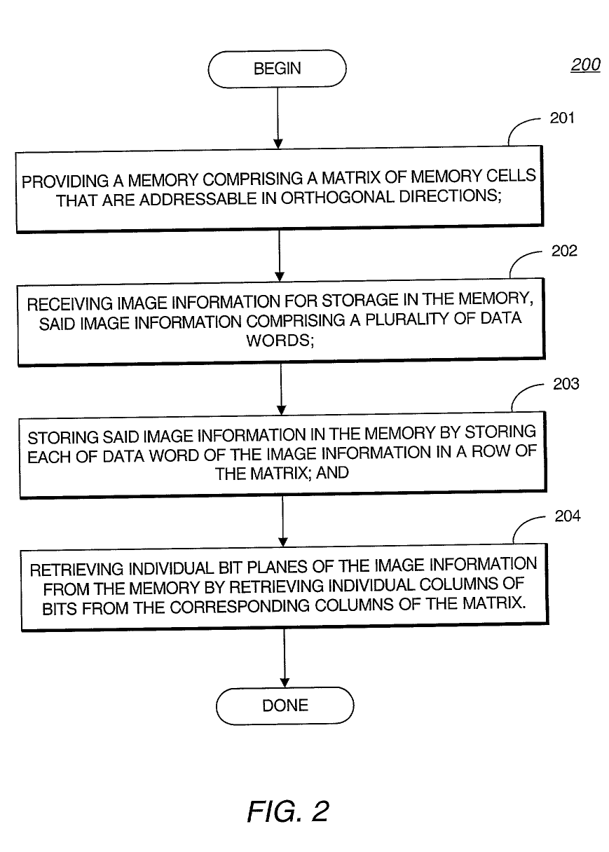

FIG. 2 is a flowchart summarizing a method 200 of the present invention for storing and retrieving image information stored in a dual-ported memory. As shown, the method includes the following steps. At the outset, a memory is provided that comprises a matrix of memory cells that are addressable in orthogonal directions, as shown at step 201. Next, image information is received for storage in the memory, as indicated at step 202. Here, data input is received via a port or bus. The image information comprises a plurality of data words, such as 8-bit, 16-bit, 32-bit, 64-bit, or 128-bit data words. At step 203, the image information is stored in the memory by storing each data word of the image information in a row of the matrix. Here, the term “row” and “column” simply indicate orthogonal addressability; there is no requirement that the memory cells themselves are actually physically configured (apart from addressability) in a particular orientation. Finally, as shown at step 204, individual bit planes of the image information may be retrieved from the memory by retrieving individual columns of bits from the corresponding columns of the matrix, thus providing a highly efficient method for storing and accessing image information used to create bit planes. This information may be outputted via an output bus or port. If desired, the inputs and outputs may share a single bus.

D. Implementation of Orthogonal Memory

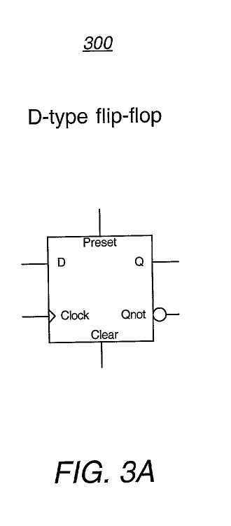

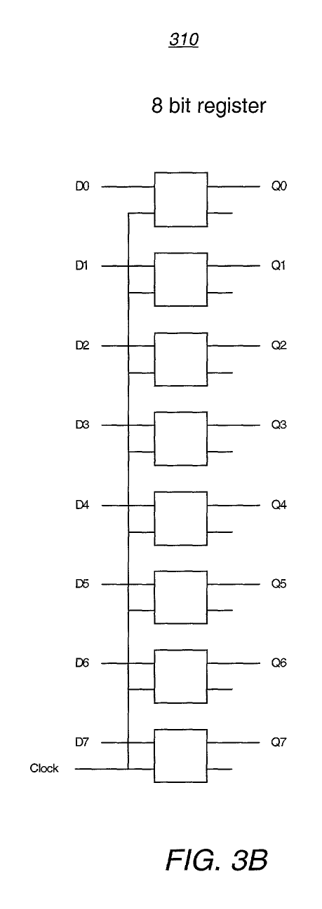

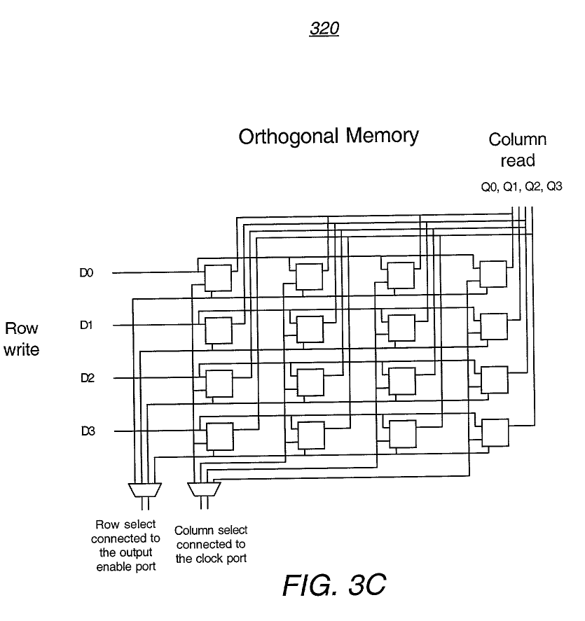

FIG. 3A shows a standard logic D-type flip-flop 300 which, in the currently preferred embodiment, serves as the basic storage element or cell. The operation simply stores the value present on the input “D” port when the clock port transitions from a “low” to “high” logic state. The stored value is made available on the “Q” port and the inverse value is made available on the “Qnot” port. For example if a high logic value is present on the “D” port, at the time that the “Clock” port transitions from a low to a high state, the high value is stored in the flip-flop and the “Q” port drives a high value, while the “Qnot” port becomes low. Two additional ports exist that are not used in this design that allow for the stored value to be forced to a specific state. If the “Preset” port is driven to a high state, the flip-flop will be forced to a high state irrespective of the state of the “D” port when the “Clock” port transitions to a from a low to high state. Similarly the “Clear” port can be used to force a low state to be stored in the flip-flop. Thus a flip-flop is able to store a single bit of information for later retrieval, the storage being controlled by the state of the clock line.

FIG. 3B diagrams the use of multiple flip-flop devices to store multiple bits in parallel, commonly referred to as a register or latch, as illustrated by register 310 in the figure. In this diagram, eight (8) bits are stored when the common clock line transitions from a low to a high state. These bits will all be stored until the next low to high clock transition. In this case, 8-bits are stored together, to form an 8-bit register. In this case there is no need for the preset, clear or Qnot functions to be used so they are not connected. It should be noted that in this case, a one-for-one correspondence exists between the input bit ordering and the output bit ordering, but other configurations may be used depending on the needs of a specific application. The bit width can be any size desired and multiple of these registers may be used in parallel to store multiple data words in separate locations. In the case of multiple registers, a decoding mechanism is required to control the clock line such that only the register or registers of interest have their clock lines transitioned to store the values as desired.

FIG. 3C diagrams a simple 4×4 orthogonal memory. As shown, orthogonal memory 320 comprises a two-dimensional matrix or array of storage elements. In this case, four 4-bit words can be written into the memory. (Practical bit widths for the memory range from 4 bits to 128 bits, or more.) The registers that store the data word are selected by the column decode circuit that decodes a 2-bit binary value and selects a single line in the range 0-3 making that line active (low to high transition). The address for the register is provided by the control circuitry for the processor and the data value is provided on the local system bus when a write operation is selected. When a read operation is decoded as valid for the orthogonal memory block, the output enable circuit for the appropriate row is enabled and the values for that row and only that row are driven onto the system bus. When multiple registers are used in this fashion, a modified “D-type” flip-flop is used that contains an output enable port; the Q value is only driven when this port is placed in a high state. Write operations are decoded into clock transition on a subset of flip-flops for storage. In this case, the decode circuitry selects a column of flip-flops for a word storage. Read operations similarly are decoded and select values to be output onto the local system bus from a row of flip-flops.

While the invention is described in some detail with specific reference to a single-preferred embodiment and certain alternatives, there is no intent to limit the invention to that particular embodiment or those specific alternatives. For instance, although the storage/retrieval process has been described in terms of horizontal write operations (rows) and vertical read operations (columns), the foregoing description may be easily couched in terms of vertical write operations (columns) and horizontal read operations (rows). Similarly the matrix does not need to be any specific size or even symmetric, as both symmetric and asymmetric are supported. Any specific implementation may be any combination of input word width and output word width, which may be different from the control processor's word width, as is optimal for the needs on the implementation. Thus, those skilled in the art will appreciate that the respective operations need only be orthogonal in nature (with respect to logical memory addresses). Accordingly, those skilled in the art will appreciate that modifications may be made to the preferred embodiment without departing from the teachings of the present invention.

What is claimed is:

1. A method for storing and retrieving image information stored in a dual-ported memory, the method comprising:
providing a memory comprising a matrix of memory cells that are addressable in orthogonal directions;
receiving image information for storage in the memory, said image information comprising a plurality of data words;
storing said image information in the memory by storing each data word of the image information in a row of the matrix; and
retrieving individual bit planes of the image information from the memory by retrieving individual columns of bits from the corresponding columns of the matrix.

2. The method of claim 1, wherein said orthogonal directions comprise a horizontal direction and a vertical direction.

3. The method of claim 1, wherein said memory is addressable via orthogonally-connected address buses.

4. The method of claim 1, wherein said image information comprises pixel values.

5. The method of claim 1, wherein said memory comprises static random access memory (SRAM).

6. The method of claim 1, wherein each said data word comprises a pixel value of a particular bit width.

7. The method claim 6, wherein said bit width is equal to at least 16 bits.

8. The method claim 1, wherein said step of storing said image includes:
storing said image information in the memory by storing successive data words of the image information in successive rows of the matrix.

9. The method of claim 1, wherein the most significant bits (MSBs) of the data words are stored on one side of the matrix, with the least significant bits (LSBs) of the data words being stored on an opposing side of the matrix.

10. The method claim 1, wherein said step of retrieving individual bit planes comprises:
retrieving bits from successive columns of the matrix.

11. The method claim 10, wherein bits are first retrieved from columns of the matrix storing the most significant bits (MSBs) of the data words.

12. The method of claim 1, wherein each said data words stored in memory is converted from 2's complement representation to a sign plus magnitude representation.

13. The method of claim 1, wherein said step of retrieving individual bit planes includes:
retrieving bits by starting with a column of most significant bits, then retrieving columns of lesser-significant bits.

14. The method claim 1, wherein said data words are stored in a manner supporting little-endian format.

15. The method of claim 1, wherein said data words are stored in a manner supporting big-endian format.

16. An orthogonal memory device comprising:
data inputs;
an array of storage elements for bit storage of information arriving from said data inputs;
an address decoding mechanism for selecting a particular row or column of storage elements, said address decoding mechanism supporting read access in a direction that is orthogonal to that for write access; and
data outputs to output data read from said storage elements.

17. The device of claim 16, wherein each storage element comprises a flip-flop.

18. The device of claim 16, wherein said array comprises a two-dimensional array of storage elements.

19. The device of claim 18, wherein said two-dimensional array is asymmetrical, such that the bit width of said two-dimensional array in one direction is not equal to the bit width of said two-dimensional array in another, orthogonal direction.

20. The device of claim 18, wherein said two-dimensional array is symmetrical, such that the bit width of said two-dimensional array in one direction is equal to the bit width of said two-dimensional array in another, orthogonal direction.

21. The device of claim 16, wherein read access occurs in a horizontal direction of the array.

22. The device of claim 16, wherein read access occurs in a vertical direction of the array.

23. The device of claim 16, wherein write access occurs in a horizontal direction of the array.

24. The device of claim 16, wherein write access occurs in a vertical direction of the array.

25. The device of claim 16, wherein said array has a bit width of at least 4 bits.

26. The device of claim 16, wherein said array has a bit width selected from between 4 bits to 128 bits.

27. The device of claim 16, wherein said data inputs comprises a port.

28. The device of claim 16, wherein said data inputs comprises a bus.

29. The device of claim 16, wherein said data outputs comprises a port.

30. The device of claim 16, wherein said data outputs comprises a bus.

31. The device of claim 16, wherein said data inputs and said data outputs share a common bus.

32. The device of claim 16, wherein said data inputs and said data outputs each employ a separate bus.

33. The device of claim 16, wherein said data inputs provide sequential pixel value information from a digital image.

34. The device of claim 16, wherein said data inputs provide non-sequential pixel value information from a digital image.

35. The device of claim 16, wherein said data inputs provide input originally in 2's complement format.

36. The device of claim 16, wherein inputs are converted to 1's complement format for storage.

37. The device of claim 16, wherein outputs are provided in 2's complement format.
